(19) United States
(12) Patent Application Publication
(10) Pub. No.: US 2003/0204434 A1
(43) Pub. Date: Oct. 30, 2003

(54) Forecast of amount in the face of uncertainty

(76) Inventors: Jonathan Daniel Linton, Maplewood, NJ (US); Julian Scott Yeomans, Toronto (CA)

Correspondence Address: JONATHAN LINTON, 629 RIDGEWOOD ROAD, MAPLEWOOD, NJ, 07040, US

(21) Appl. No.: 10/133,881

(22) Filed: Apr. 29, 2002

(51) Int. Cl. G06F 17/60

(52) U.S. Cl. 705/10

(57) ABSTRACT

A method and machine for determining the likely value of an amount or amounts in the face of uncertainty. The invention relates to an improved method of forecasting or prediction. More specifically the use of resampling to obtain better predictions of unknown values through the consideration of uncertainty. The method can determine supply, demand, supply/demand gaps, price, cost, proportion, policy choice, amounts, quantities, levels, needs, requirements and other values that are difficult to determine due to the presence of one or more uncertainties.

### CROSS-REFERENCE TO OTHER APPLICATIONS

Not applicable.

### BACKGROUND

1. Field of the Invention

This invention relates to forecasting, specifically to an improved method of forecasting based on incorporation of uncertainty in variables and/or relationships between variables by using multiple predictions of possible future states.

2. Description of Prior Art

U.S. Pat. Nos. 5,459,656, 5,712,985, 5,819,232, and 6,101,460 have made predictions or forecasts regarding different amount(s) based on previous data and experiences. Texts on forecasting rely heavily on methods of predicting amount based on reliance of patterns in past data and the assumption that the past and future are similar. Examples of such texts include Porter et al. (1991), Wilson and Keating (1994), and Hanke and Reitsch (1998). Such methods do not reflect the possibility that future amounts may not be based on patterns that are clearly discernible from the direct manipulation of past data. One of the flaws in predictions based on these methods is that they do not take into account the variables and relationships between variables that underlie the amount. U.S. Pat. Nos. 4,937,743, 5,233,533, 5,699,525 5,781,893, 5,918,207, 6,049,774, 6,064,974, and 6,188,989 attempt to take this problem partially into account by considering the relationship between underlying variables and current data to calculate the value of an amount for the present time period. These patents do address one of the flaws of earlier work—that is they consider the relationship(s) between underlying variables. But these patents do not allow for predictions of future amount only of present amount.

The methods in earlier patents are limited to calculations of the present amount, because they rely on the collection of data relating to the current situation to assist with decision making. The difference between the present and the future is the introduction of uncertainty. To address uncertainty, we consider the application of Bootstrapping, also known as resampling, a technique described by Bradley (1982) and others to consider a number of different possible outcomes. Efron and Tibshirani (1993) have demonstrated a wide range of applications for the bootstrap. However, it has not been applied to forecasting possible future amounts or quantities. The novelty presented in this patent is the application of resampling to determine, forecast or predict the amount based on the variables, relationships and associated uncertainty that the amount being calculated is dependent on.

The only two papers relating in a relevant, but different, manner to forecasting using the bootstrap are now considered. Steven Peters and David Freedman in their 1985 paper Using the bootstrap to evaluate forecast equations demonstrated how the bootstrap could be used to show which equations should be selected for forecasting using differences in forecast error. It differs from the proposed patent, in that we propose the use of the bootstrap or resampling for taking into account uncertainty between the variables and relationships between variables that are used to calculate values of an amount of interest some time in the future. Whereas, Peters and Freedman suggests that resampling is used to choose between alternative equations for forecasting. In summary, their paper is limited to the idea of selection between forecast equations. Chris Chatfield in his 1993 paper Calculating interval forecasts describes the use of bootstrapping to offer an interval forecast, thereby providing a better understanding of the relative accuracy of different forecasts. Chatfield suggests the use of bootstrapping to obtain more information about the nature or quality of a forecast. In summary, his paper describes the theoretical value of bootstrapping specifically for generating an interval, as opposed to our proposal of actual application of bootstrapping to forecasting to provide utility using different ways of displaying the data.

### SUMMARY

The present invention provides a process and system for predicting, forecasting or determining amounts that substantially eliminates or reduces disadvantages and problems associated with previously developed methods of forecasting.

Objects and Advantages

According to one embodiment of the present invention, a process is provided for forecasting to allow a stakeholder to determine an amount of interest. The process is implemented using a computer having a data storage device for storing data in a data base repository. The process involves determining the relevant variables, relationships between variables and uncertainty associated with both variables and relationships and storing the data representing the variables and their relationships in the data base repository. Based on the variables and relationships the amount(s) are predicted and stored in the data base repository. The stakeholder then can examine the set of predictions and obtain the forecast or prediction of the amount in the form that is considered useful.

A technical advantage of the present invention is that it allows for consideration of the effect of numerous different variables on the amount calculated.

The present invention provides a further advantage by allowing for the consideration of a variable(s) having a fixed value.

Another advantage of the present invention is that it allows for the consideration of fixed value relationship(s) between any of the variables.

The present invention also allows for the consideration of a variable(s) having uncertain values, where the distribution of possible values of the variables can have any distribution that is possible to describe.

In addition, the present invention allows for the consideration of uncertain relationships between any of the variables, where the distribution of possible values of the relationship can have any distribution that is possible to describe.

The present invention has the advantage of allowing for the determination of as many different possible values of the amount to be predicted as desired.

The present invention offers the important technical advantage of allowing for the determination of statistics regarding the likely value that is to occur.

The present invention offers the advantage of the determination of possible values for supply of a product of interest. In addition, the present invention allows for the determination of possible values for demand of a product of interest. The present invention also allows for the determination of possible values of a quantity of interest, such as supply, demand or the gap between supply and demand. Furthermore, the present invention allows for the determination of possible values of a cost or price of interest. Also, the present invention allows for the determination of possible values of a proportion of interest. In addition the present invention allows for the determination of a decision or policy, based on the use of resampling to take into account uncertainty. Finally, the present invention allows for the determination of possible values of a rate or level of interest; applications of this include but are not limited to routing, investment level, determination of needs and infrastructure requirements.

### DRAWING FIGURES

A more complete understanding of the present invention and the advantages thereof may be acquired by referring to the following description taken in conjunction with the accompanying drawings in which like reference numerals indicate like features and wherein:

FIG. 1 is a flow diagram of one embodiment of a process for forecasting amount according to the present invention;

FIG. 2 is a flow diagram of one embodiment of the determination of the variables and relationships between the variables of FIG. 1;

FIG. 3 is a flow diagram of one embodiment of the determination of possible values and distribution of values of FIG. 1;

FIG. 4 is a flow diagram of one embodiment of the determination of the calculation of forecast amount of FIG. 1;

FIG. 5 is a diagram depicting the set of variables and dependencies between the variables for one possible example of a forecast using the process described in FIGS. 2 and 3;

FIG. 6 displays, identifies, and defines the variables used in FIG. 5, using the process described in FIGS. 2 and 3;

FIG. 7 displays, identifies, and defines the relationship between the variables used in FIG. 5, using the process described in FIGS. 2 and 3;

FIG. 8 displays the forecast output for the example and illustrates a variety of ways of describing the results obtained by completing the process described in the flow chart in FIG. 4.

### DESCRIPTION OF THE INVENTION

Purpose

The present invention provides a process and system for forecasting or prediction of an uncertain amount. This enables for decisions and preparations to be made in expectation of this amount. There are many instances when the determination of an uncertain amount is of great importance. By understanding the likely quantity of an amount and the possible alternate values. The forecast in the face of uncertainty offers the potential values of the amount and the associated likelihoods that these amounts will occur. The forecast in the face of uncertainty can be conducted for determination of demand, supply, cost, price, amount, proportion, rate, value, requirements, level, absence/presence or other units. The forecast in the face of uncertainty considers all the variables and the relationships between the variables that influence the amount under consideration. The forecast under uncertainty includes the consideration of all the possible values of variables and relationships between variables. In addition, it includes the consideration of the distribution of all the possible variables and uncertainty in the relationship between variables. Through the use of random sampling a population of different potential values can be obtained, this population can be used to offer insights into the various possible values, their likelihood and other relevant statistics.

Form

The forecast of the amount in the face of uncertainty method and system of the present invention includes a software tool executable on a computer having a data storage device for automatically implementing steps in the forecasting of the amount in the face of uncertainty process. The system stores information necessary to support the forecast processes into a repository of data such as a relational database, searches and compares that data, provides potential values and statistics as well as a variety of reports.

In one embodiment of the present invention, the software tool supports many forecasting functions. The software tool stores information necessary to support the forecasting of ranges as well as the degree of balance and imbalance between forecasts for related values. The software tool can also access the database to compile a variety of reports including a report on the suitability of future plans or policies to meet requirements associated with the product(s) that have been forecasted in the face of uncertainty. One embodiment of the software tool has a WINDOWS based interface using a MICROSOFT EXCEL MANAGEMENT SYSTEM.

Operation

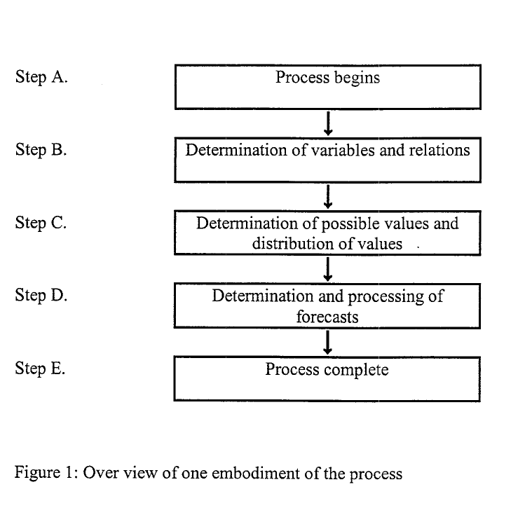

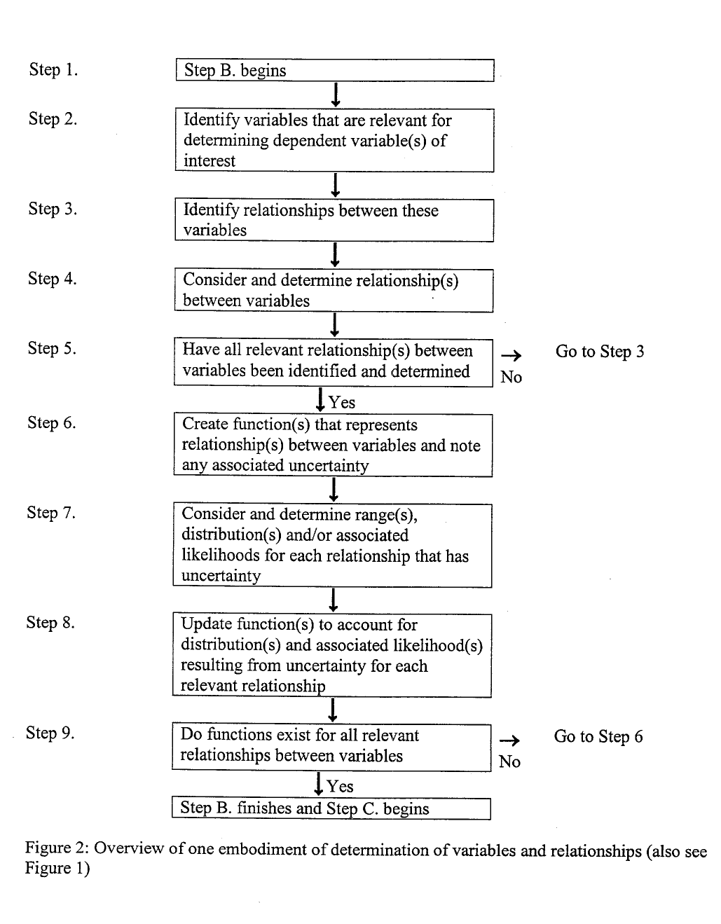

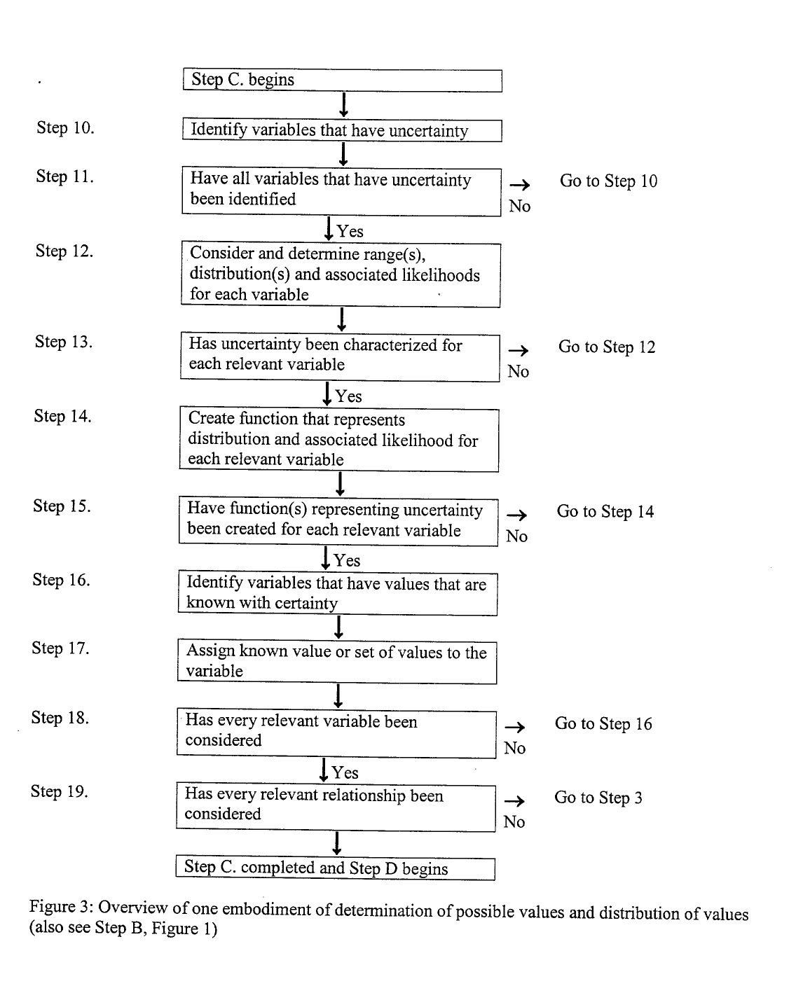

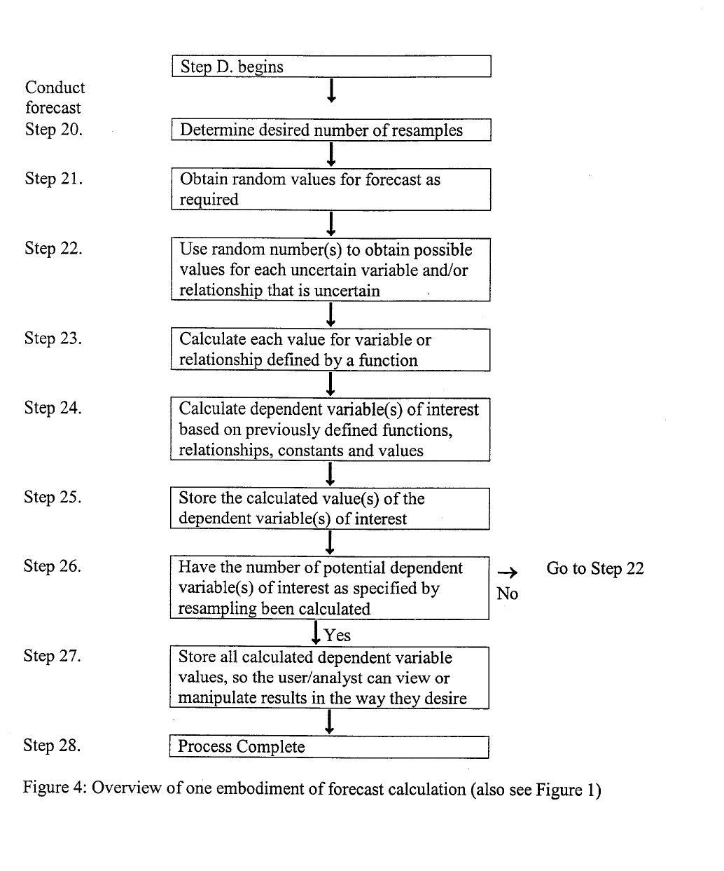

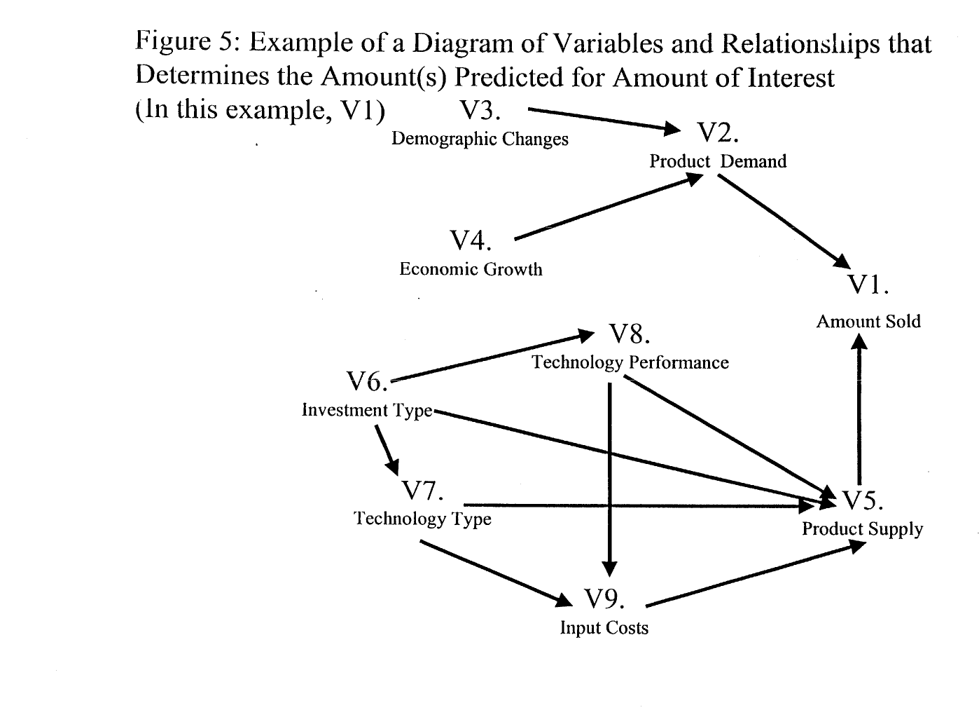

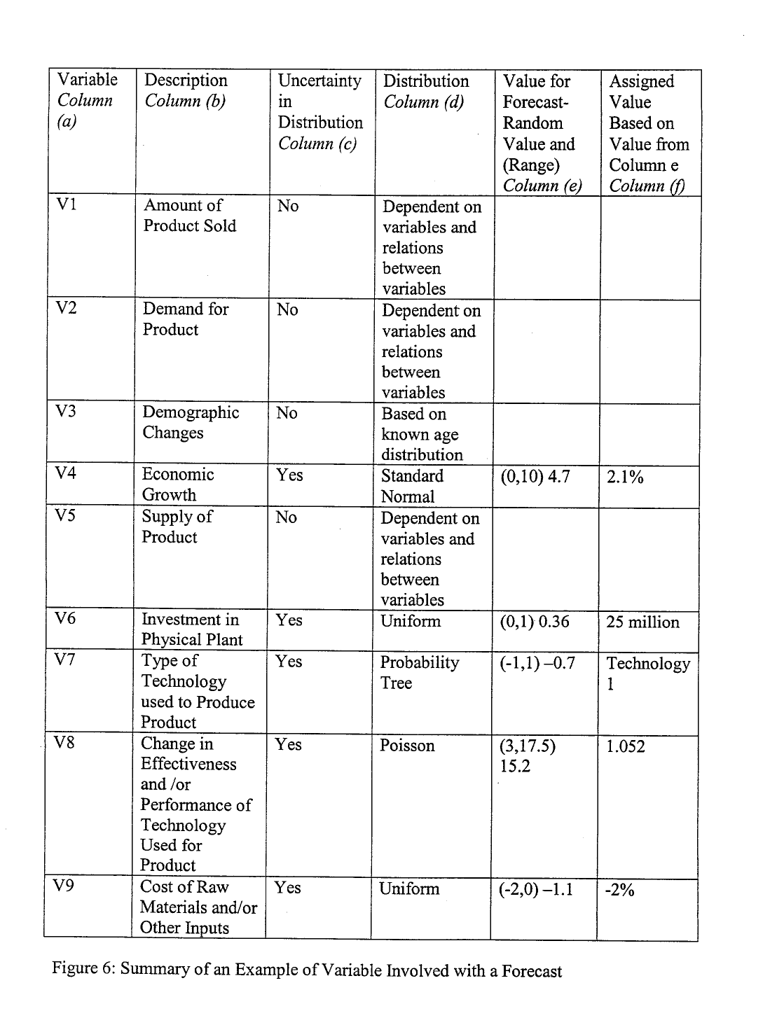

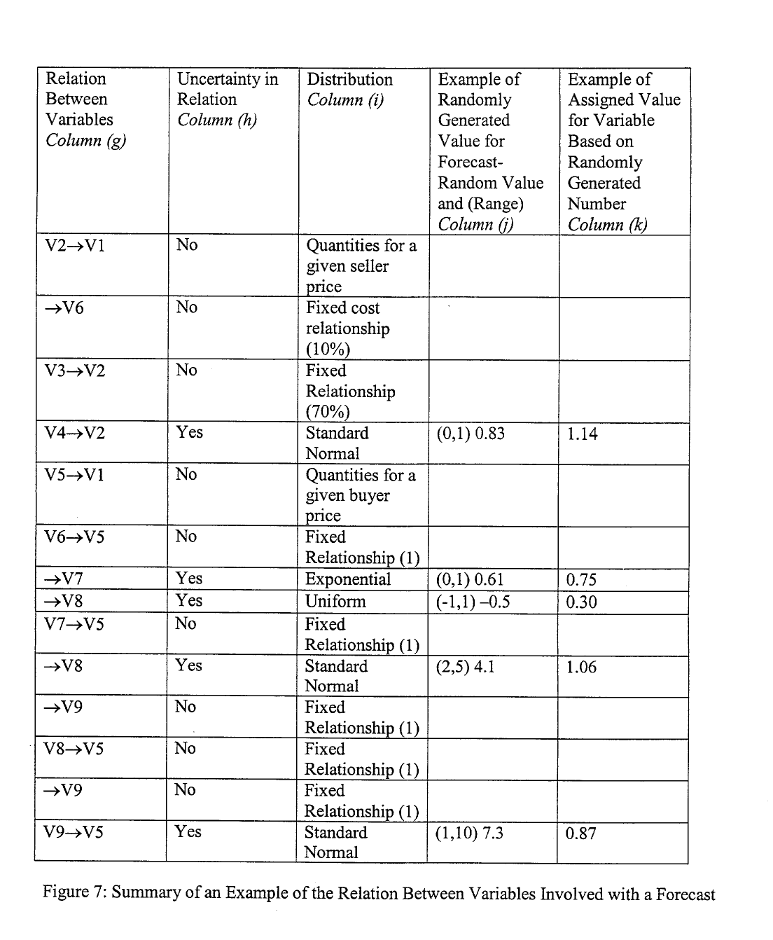

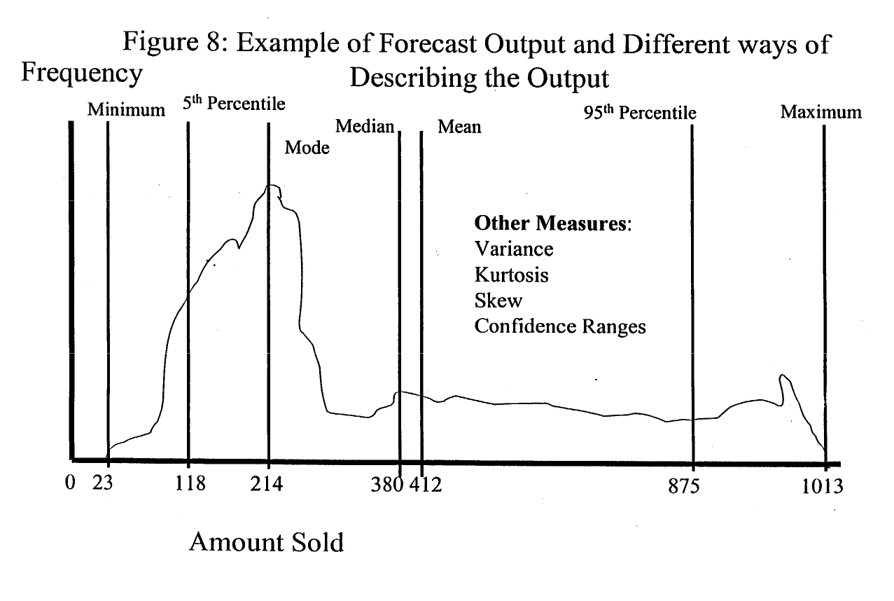

An embodiment of the method and software tool are offered by FIG. 1 through FIG. 8. FIG. 1 summarizes one embodiment of the process that is offered in more detail by FIGS. 2, 3, and 4. FIG. 1 identifies the first step (Step B, FIG. 1) of the process to be the determination of variables and the relations between the variables. The purpose of this step is to determine what variables and associated relationships may have an influence on the value(s) of interest that is to be predicted. This process identified in Step B, FIG. 1 is considered in further detail in FIG. 2. First, in Step 2 variables that may have an influence on the value(s) to be predicted are listed. (In FIG. 6, see Columns a and b, examples of relevant variables are offered.) In Step 3, the existence (presence or absence) of possible relationships between the variables is determined. In FIG. 5, a graphical example is given of a series of variables and the possible relationships between the variables and with the value to be forecasted. These relationships are also listed in Column g of FIG. 7. In Step 4, the nature, distribution and/or possible values and associated likelihoods between the variables are considered. (In FIG. 7, see Columns g and h, uncertainty in relationship, and Column i, distribution.) Having completed this, the question of have all relevant variables and relationships between variables been identified is asked in Step 5. If all relevant variables and relationships between variables have not been identified, then the process returns to Step 3. Otherwise, Step 6—create functions that represent the relevant relationships between the different variables and the value(s) to be forecast occurs. Identify which relationships between variables, in the function(s) involve uncertainty (see Column h, FIG. 7). Having created functions representing the relationships and having identified which of these relationships involve uncertainty; the value(s), range(s), distribution(s) and/or associated likelihood(s) associated with relationship are identified (see Column i, FIG. 7.)—Step 7. In Step 8, the function(s), from Step 6, are updated to reflect the information regarding the relationships between variables—both certain and uncertain. Having updated the function(s), the variables and functions are examined to determine whether the function(s) consider all the relevant variable relationships—in Step 9. If there are additional relationships that should be considered, the process returns to Step 6. Otherwise, the process continues with the determination of the possible values and distribution of values in FIG. 3 (Steps 10 through 19). In Step 10, all variables that involve uncertainty are identified (see Column c, FIG. 6). If all variables with uncertain values (Step 11) have not been identified, return to Step 10 of the process. Having identified all variables with uncertain values, consideration and determination of all the range(s), distribution(s) and associated likelihood(s) for each variable occurs—in Step 12 (also see Column d, FIG. 6). If the uncertainty for all variables with uncertainty (Step 13) has not been complete, return to Step 12 of the process. Having characterized all the uncertainty in variables, create function(s) that represent the distribution(s) and associated likelihood(s) for each relevant variable—in Step 14. If the function(s) representing the uncertainty for all variables with uncertainty (Step 15) has not been complete, return to Step 14 of the process. Having created function(s) for each relevant variable, identify the variables that have values that are known with certainty—Step 16 (also see Column c, FIG. 6). Next in Step 17, the known value, or set of values, are assigned to the variable that they correspond to. If every relevant variable (Step 18) has not been considered and addressed, return to Step 10 of the process. Having considered every relevant variable, it is determined whether every relevant relationship between variables has been considered—in Step 19. If every relevant relationships has not been considered, then the process returns to Step 3 (FIG. 2). Otherwise, the process progresses to Step D (FIG. 1) and FIG. 4 (Steps 2 through 28) the calculation of forecasts. The calculations for the forecast(s) (FIG. 4), commences with the determination of the desired number of resamples (Step 20). The number of resamples to be used for the forecast is determined by the analyst or user, but can be given a default value. A larger number of steps offers a better forecast, but requires more time to determine. Having determined the number of resamples a sufficient number of random numbers are generated (Step 21). Random numbers are required for each uncertain variable (see Column e, FIG. 6) and uncertain relationship between variables for each resample (see Column j, FIG. 7). (These random numbers are used to obtain values for uncertain variables and relationships that are represented by distributions of values, ranges of values, and/or values with associated likelihoods.) In Step 22, the random numbers are now used in conjunction with the distributions, ranges and likelihoods to obtain a possible value for each uncertain variable (see Columns e and f, FIG. 6) and uncertain relationship between variables (see Columns j and k, FIG. 7) for each resample. Next in Step 23, the value for each variable (see Column f, FIG. 6) and relationship between variables (see Column k, FIG. 7) is calculated using their defined functions (refers to FIGS. 2 and 3, Steps 6, 8, and 14). Having calculated the function and having obtained values for the variables and relationships between the variables, in Step 24, the dependent variable(s) or items of interest are calculated. The calculated values of the dependent variable(s) or items of interest are stored—Step 25. In Step 26, it is checked whether the number of resamples equals the number of calculations for the dependent variables or items of interest, if too few calculations have been made the process returns to Step 22. Otherwise in Step 27, all the calculated values of the dependent variables of interest are stored in such a manner that the user/analyst can view or manipulate the results in the way that is desired. In FIG. 9, examples are offered of some of the different ways in which a user/analyst may want to view the population of predictions of the dependent variable(s) or items of interest.

Conclusions, Ramifications, and Scope

Thus the reader will see that the method and machine described here is of great value for obtaining forecasts for items of interest in the face of uncertainty. Such a method and machine has value in a variety of applications including determining demand, supply, gap between supply and demand, routing, quantity, level, price, cost, proportion, rate, amount, quantity, investment decisions, policy decisions and determination of needs and infrastructure requirements.

While the above description contains many specificities, these should not be construed as limitations on the scope of the invention, but rather as an exemplification of one preferred embodiment thereof. For example, values and distributions associated with relations between variables are considered prior to and fully before values and distributions associated with variables being considered. It is possible that the order could be reversed first consider variables then consider relationships between variables. Alternatively, variables and the relationship between variables could be considered simultaneously. Another example, is that if multiple variables are to be forecast in the face of uncertainty, given the method described above each step for the separate variables to be forecast occur at the same time. Alternatively, the process for forecasting multiple variables in the face of uncertainty could be accomplished through the process being completed for each variable of interest, prior to the commencement of analysis of the next variable—assuming the values of the variables of interest are independent of each other. These are just as a few examples of the variation that could occur within the scope of the proposed method and machine.

Accordingly, the scope of the invention should be determined not by the embodiment(s) illustrated, but by the appended claims and their legal equivalents.

I claim:

1. A method for predicting the value and values of items of interest using a computer having memory, including the steps of:
identifying relevant variables and relationships between variables;
Identifying whether the said variables and said relationships between values have uncertainty;
identifying the value, values, distribution of values of said variables and said relationships between variables;
creating a database of information on a least some of the said variables and said relationships between variables;
calculating possible values for the said items of interest using resampling and at least some of the said variables and the said relationships between variables;
displaying in graphical fashion either the said possible values and/or some statistic(s) representing the said possible values;

2. The method of claim 1 where in at least some of the said variables have uncertainty in their value.

3. The method of claim 1 where in at least some of the said relationships between the said variables have uncertainty.

4. The method of claim 1 where the said value of interest is a quantity.

5. The method of claim 4 where the said quantity represents the demand for a product.

6. The method of claim 4 where the said quantity represents the supply of a product.

7. The method of claim 4 where the said quantity represents a proportion.

8. The method of claim 7 where the said proportion represents part of a portfolio of investments or investment decision.

9. The method of claim 4 where the said quantity represents a likelihood of an event occurring.

10. The method of claim 4 where the said quantity represents an amount to travel along a route in a network.

11. The method of claim 4 where the said quantity represents one or more policy alternatives.

12. The method of claim 11 where the quantity represents the extent and/or magnitude of the said policy(s).

13. The method of claim 4 where the quantity represents the cost.

14. The method of claim 4 where the quantity represents the price.

15. The method of claim 4 where the quantity represents a requirement or need.

16. The method of claim 4 where the quantity represents a level.

17. The method of claim 4 where the quantity represents a rate.

18. The method of claim 4 where the quantity represents a gap between supply and demand.

19. The method of claim 4 where the quantity represents an amount.

20. The method of claim 4 where the quantity represents an infrastructure requirement.

21. A system for prospectively determining the value or values of an item of interest utilizing a multiplicity of variables, al least some of which are interrelated, comprising:
a computer having a memory;
a data base stored in said memory containing information about at least some of said variables and the relationships between these said variables;
means for calculating predictions of value(s) of interest utilizing said variables and said relationships between variables;
display means for displaying in graphical form, the variables and values that result from the processing of said variables;

22. The system of claim 21 wherein at least some of the said variables have uncertainty in their value.

23. The system of claim 21 where in at least some of the said relationships between the said variables have uncertainty.

24. The system of claim 21 where the said value of interest is a quantity.

25. The system of claim 24 where the said quantity represents the demand for a product.

26. The system of claim 24 where the said quantity represents the supply of a product.

27. The system of claim 24 where the said quantity represents a proportion.

28. The system of claim 27 where the said proportion represents part of a portfolio of investments or investment decision.

29. The system of claim 24 where the said quantity represents a likelihood of an event occurring.

30. The system of claim 24 where the said quantity represents an amount to travel along a route in a network.

31. The system of claim 24 where the said quantity represents one or more policy alternatives.

32. The system of claim 31 where the quantity represents the extent and/or magnitude of the said policy(s).

33. The system of claim 24 where the quantity represents the cost.

34. The system of claim 24 where the quantity represents the price.

35. The method of claim 24 where the quantity represents a requirement or need.

36. The method of claim 24 where the quantity represents a level.

37. The method of claim 24 where the quantity represents a rate.

38. The method of claim 24 where the quantity represents a gap between supply and demand.

39. The method of claim 24 where the quantity represents an amount.

40. The method of claim 24 where the quantity represents an infrastructure requirement.
